(19) United States
(12) Patent Application Publication
(10) Pub. No.: US 2016/0368273 A1
(43) Pub. Date: Dec. 22, 2016

(54) LIQUID DROPLET EJECTING APPARATUS THAT REDUCES FLUCTUATION OF LIQUID PRESSURE DURING LIQUID EJECTION

(71) Applicant: TOSHIBA TEC KABUSHIKI KAISHA, Tokyo (JP)

(72) Inventor: Hiroyuki ISHIKAWA, Kannami Tagata Shizuoka (JP)

(21) Appl. No.: 15/180,947

(22) Filed: Jun. 13, 2016

(30) Foreign Application Priority Data
Jun. 16, 2015 (JP) 2015-121207

(51) Int. Cl. B41J 2/175; B41J 2/19; B41J 2/20

(52) U.S. Cl. CPC B41J 2/17566; B41J 2/20; B41J 2/19; B41J 2/17596; B41J 2/17563; B41J 2202/07

(57) ABSTRACT

A liquid droplet ejecting apparatus includes a liquid chamber, a head including a plurality of pressure chambers to which liquid is supplied from the liquid chamber and a plurality of nozzles, each being disposed on one of the pressure chambers, a driver configured to cause liquid droplets to be ejected from the nozzles, a pressure adjuster configured to adjust pressure of liquid in the liquid chamber, and a controller. The controller is configured to output a control signal to control the driver to cause ejection of the liquid droplets, and cause pressure of the liquid in the liquid chamber to increase at the time or before the control signal starts to be output, by controlling the pressure adjuster.

### CROSS-REFERENCE TO RELATED APPLICATION

This application is based upon and claims the benefit of priority from Japanese Patent Application No. 2015-121207, filed Jun. 16, 2015, the entire contents of which are incorporated herein by reference.

### FIELD

Embodiments described herein relate generally to a liquid droplet ejecting apparatus in which a meniscus is formed at a liquid droplet ejecting end of a nozzle, and liquid droplets are ejected from the nozzle.

### BACKGROUND

A conventional liquid droplet ejecting apparatus supplies liquid to a head from a tank, and causes liquid droplets to be ejected through nozzles of the head. In such a liquid droplet ejecting apparatus, a meniscus is formed at each of the nozzles, and liquid droplets are ejected by being separated from the meniscus. It is preferable to instantly reform the meniscus after each ejection of liquid droplets, in order to stabilize the ejection thereof.

To reform the meniscus, the pressure of the liquid at the nozzle is monitored, and if the monitored pressure is lower than the predetermined value after the ejection of liquid droplets, liquid is replenished so that the pressure of the liquid is recovered to a predetermined value.

However, air bubbles may mix into liquid remaining in the nozzle as soon as pressure of the liquid becomes lower than the predetermined value. Such air bubbles in the liquid may negatively affect stable ejection of liquid droplets.

Therefore, it is desirable to reduce generation of air bubbles, and further stabilize the ejection of liquid droplets.

### DESCRIPTION OF THE DRAWINGS

FIG. 1 is a side view of an ink jet apparatus according to an embodiment.

FIG. 2 is a plan view of the ink jet apparatus in FIG. 1.

FIG. 3 is a side view of an ink jet head unit in the ink jet apparatus in FIG. 1.

FIG. 4 is a side view of the ink jet head unit from an angle opposite to the angle in FIG. 3.

FIG. 5 schematically illustrates functional elements of the ink jet head unit in FIG. 3.

FIG. 6 is a cross-sectional view of an ink jet head of the ink jet head unit in FIG. 3.

FIG. 7 illustrates an ink-maintaining state of a nozzle of the ink jet head in FIG. 6.

FIG. 8 illustrates an ink-ejecting state of the nozzle, in which ink droplets are ejected from the nozzle.

FIGS. 9A to 9C illustrate a configuration and operations of a pressure adjusting mechanism in the ink jet head unit in FIG. 3.

FIG. 10 is a block diagram of a control system of the ink jet apparatus in FIG. 1.

FIG. 11 is a flowchart which illustrates a control operation according to the embodiment.

FIG. 12 is a timing chart of signals used in the control operation carried out along with the flowchart in FIG. 11.

FIG. 13 is a graph which illustrates a pressure change of ink during ejection of ink droplets according to a comparative example.

FIG. 14 is a graph which illustrates a pressure change of ink during ejection of ink droplets according to the embodiment.

### DETAILED DESCRIPTION

In general, according to an embodiment, a liquid droplet ejecting apparatus includes a liquid chamber, a head including a plurality of pressure chambers to which liquid is supplied from the liquid chamber, each pressure chamber having a nozzle, a driver configured to cause liquid droplets to be ejected from the nozzles, a pressure adjuster configured to adjust pressure of liquid in the liquid chamber, and a controller. The controller is configured to output a control signal to control the driver to cause ejection of the liquid droplets, and cause pressure of the liquid in the liquid chamber to increase at the time or before the control signal starts to be output, by controlling the pressure adjuster.

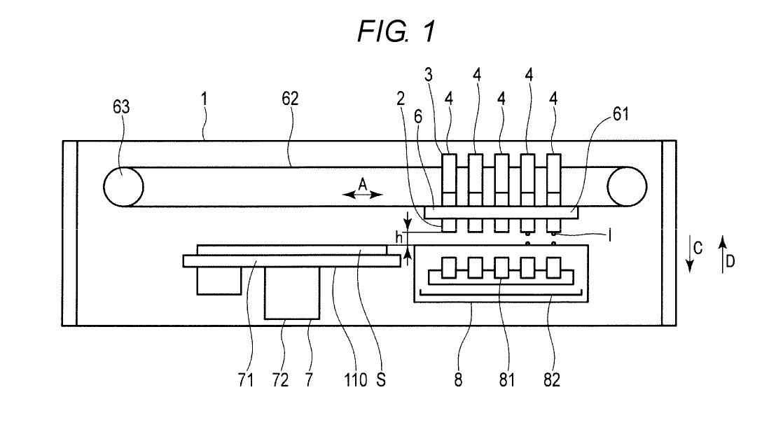

Hereinafter, an ink jet apparatus (image forming apparatus) 1 according to an embodiment will be described with reference to FIGS. 1 to 10. In each figure, the illustrated dimensions of components may be scaled to aid in description.

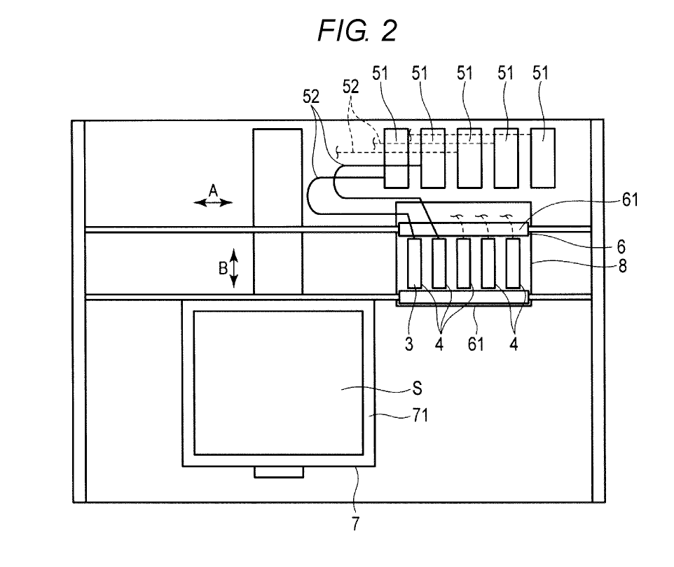

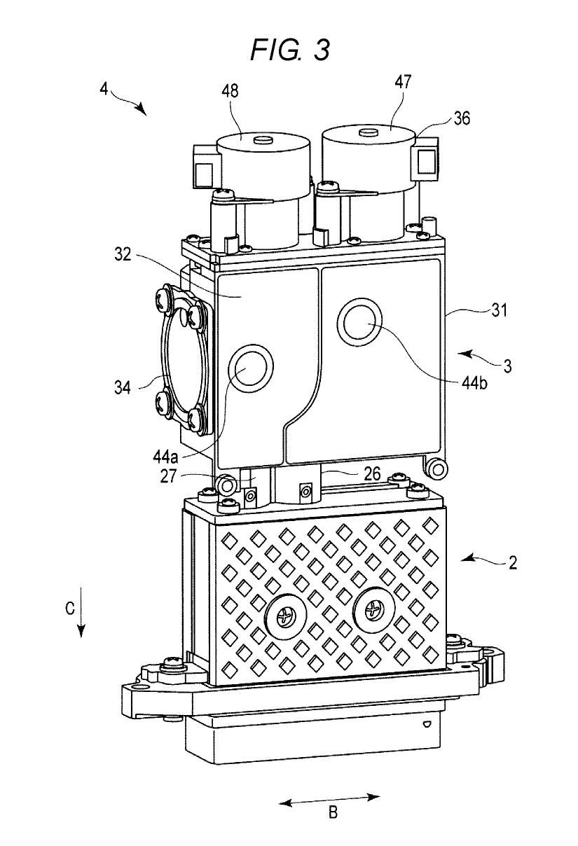

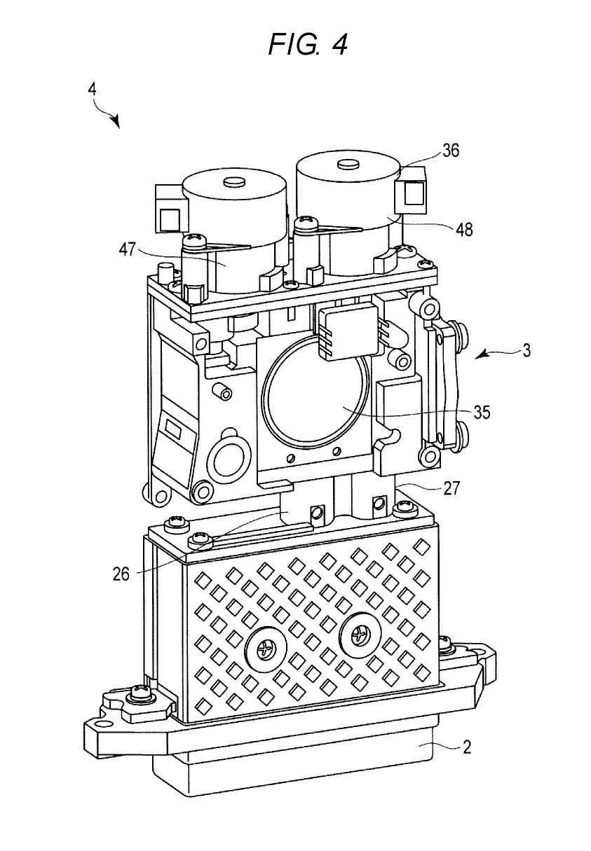

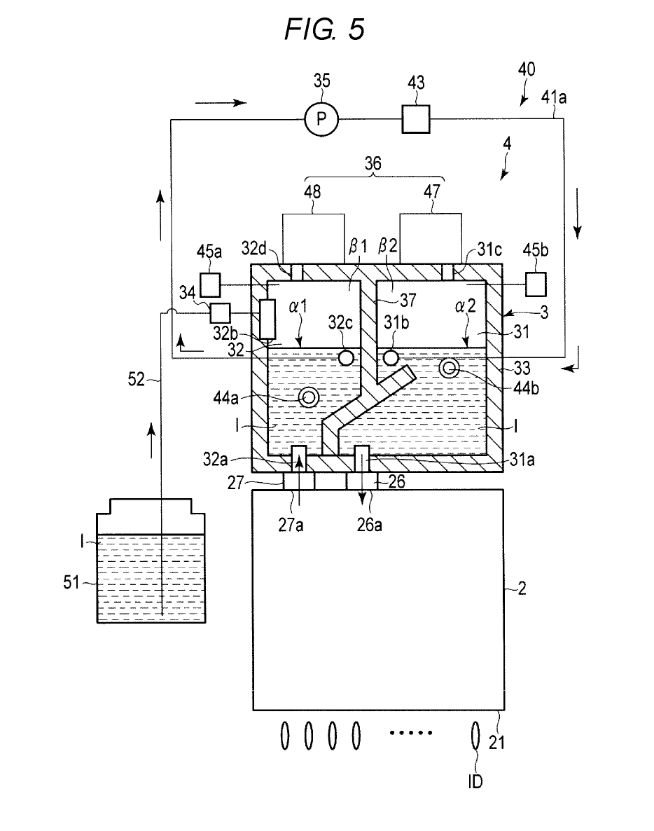

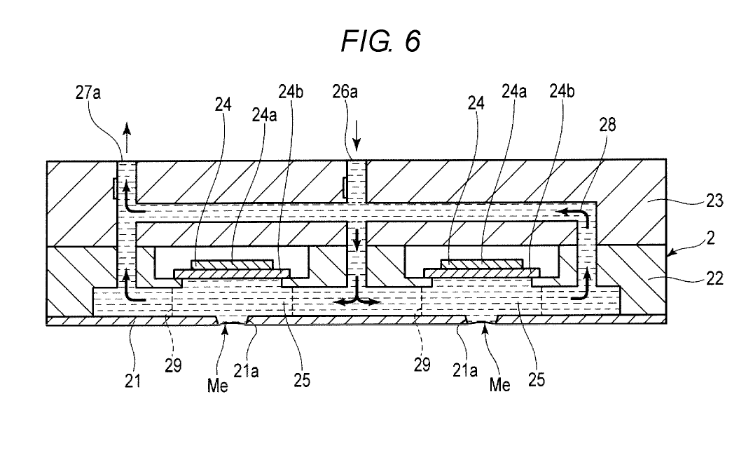

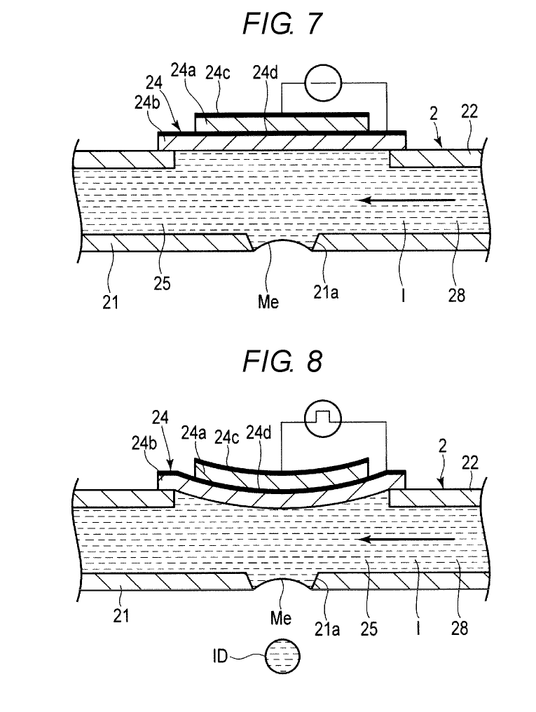

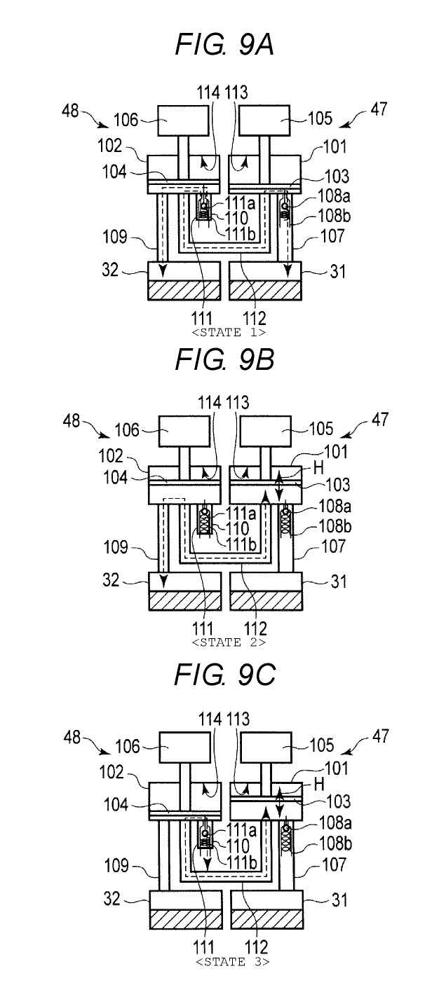

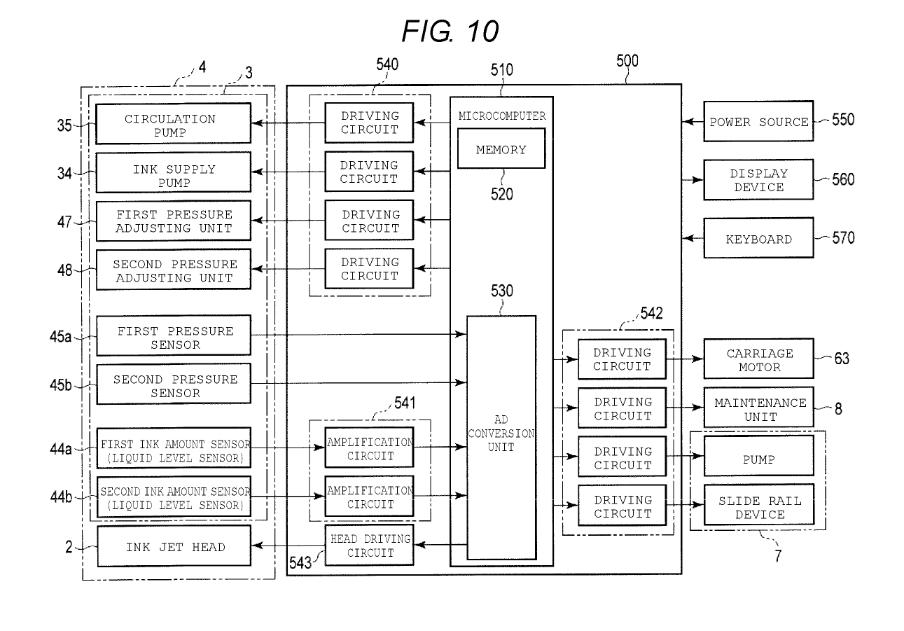

FIG. 1 is a side view of the ink jet apparatus 1, and FIG. 2 is a plan view of the ink jet apparatus 1. FIGS. 3 and 4 are perspective views of an ink jet head unit 4, and FIG. 5 schematically illustrates functional units of the ink jet head unit 4. FIG. 6 is a cross-sectional view of an ink jet head 2. FIGS. 7 and 8 illustrate an ink ejecting operation of the ink jet head 2. FIGS. 9A to 9C illustrate a configuration and operations of a pressure adjusting unit 36. FIG. 10 is a block diagram of a control system of the ink jet apparatus 1.

As illustrated in FIGS. 1 and 2, the ink jet apparatus 1 includes a plurality of the ink jet head units 4 as one embodiment of a liquid droplet ejecting apparatus, a plurality of ink cartridges 51 each of which contains ink to be supplied to corresponding one of the ink jet head units 4, a head support unit 6 which movably supports the ink jet head unit 4, a medium moving unit 7 which movably supports a medium, and a maintenance unit 8.

As illustrated in FIGS. 3 to 5, each ink jet head unit 4 includes the ink jet head 2 (ejecting head), and an ink circulating device 3 which is integrally provided at an upper portion of the ink jet head 2. The ink circulating device 3 of each of the ink jet head units 4 is one embodiment of a liquid circulating device which causes ink to circulate in the ink jet head 2.

In the plurality of ink jet head units 4, cyan ink, magenta ink, yellow ink, black ink, and white ink are circulated as liquid, for example, are ejected onto a medium, respectively, and form a desired image. In addition, colors or characteristics of ink used in each of the ink jet head units 4 can be variously changed. For example, it is also possible to use transparent and glossy ink, ink which develops color when being irradiated with infrared light or UV light, or the like, instead of the white ink.

Each of ink jet head units 4 has the same configuration, although ink to be used in the ink jet head units 4 is different. Accordingly, in the descriptions below, one ink jet head unit 4 will be representatively described, and descriptions of the ink jet head unit 4 of each color will be omitted.

As illustrated in FIG. 6, the ink jet head 2 of the ink jet head unit 4 includes a nozzle plate 21 which has a plurality of nozzle holes 21a, a substrate 22 arranged to face the nozzle plate 21 and to which a plurality of actuators 24 is attached, and a manifold 23 which is bonded to the substrate 22.

The nozzle plate 21 has a first nozzle column and a second nozzle column which include three hundred nozzle holes 21a, respectively, for example. A predetermined ink flow path 28 is defined in the inside of the ink jet head 2 by the nozzle plate 21, the substrate 22, and the manifold 23.

The substrate 22 is bonded to the nozzle plate 21 and defines a plurality of ink pressure chambers 25 between the substrate 22 and the nozzle plate 21. The actuator 24 is disposed at a portion of the substrate 22 that faces each of the ink pressure chambers 25. The substrate 22 includes a plurality of partitioning walls 29 arranged between the plurality of ink pressure chambers 25 on the same column. Each of the actuators 24 is arranged so as to face one of the nozzle holes 21a, and each of the ink pressure chambers 25 is provided between one of the actuators 24 and corresponding one of the nozzle holes 21a.

The manifold 23 is bonded to the upper surface of the substrate 22 in FIG. 6. The manifold 23 includes a supply port 26a and an ink discharging port 27a which communicate with the ink circulating device 3. The manifold 23, substrate 22, and the nozzle plate 21, define a predetermined ink flow path 28.

The ink flow path 28 is connected to the plurality of ink pressure chambers 25 which communicate with the nozzle holes 21a through a common flow path from the supply ports 26a in the manifold 23, and is connected to the ink discharging port 27a through a common flow path from each of the ink pressure chambers 25.

The actuator 24 illustrated in FIGS. 6 to 8 is a unimorpf-type piezoelectric vibration plate which is formed by stacking a piezoelectric element 24a and a vibration plate 24b, for example. The piezoelectric element 24a is formed of a piezoelectric ceramic material, or the like, such as lead zirconate titanate (PZT), for example. The vibration plate 24b is formed of silicon nitride (SiN), or the like, for example. As illustrated in FIGS. 7 and 8, the piezoelectric element 24a includes electrodes 24c and 24d in the vertical direction in FIGS. 7 and 8.

Since the piezoelectric element 24a is not deformed when no voltage is applied between the electrodes 24c and 24d, the actuator 24 is not deformed. When the actuator 24 is not deformed, an ink meniscus Me as an interface between ink I and the atmosphere (the air) is formed at a liquid droplet ejecting end of the nozzle hole 21a due to a surface tension of ink. Ink I in the ink pressure chamber 25 remains in the nozzle hole 21a due to the ink meniscus Me.

As illustrated in FIG. 8, when a voltage V is applied between the electrodes 24c and 24d, the piezoelectric element 24a is deformed, and the actuator 24 is deformed. Due to deformation of the actuator 24, pressure applied to the ink meniscus Me becomes higher than atmospheric pressure (positive pressure), and ink I forms an ink droplet ID, which is separated from the ink meniscus Me and ejected.

According to the ink jet head 2 having the above structure, when a pressure applied to the ink meniscus Me of the nozzle hole 21a is equal to or higher than atmospheric pressure, i.e., a positive pressure, ink I is ejected from the nozzle hole 21a as ink droplet ID. On the other hand, when the pressure applied to the ink meniscus Me of the nozzle hole 21a is lower than atmospheric pressure, i.e., a negative pressure, ink I maintains the ink meniscus Me, and remains in the nozzle hole 21a.

For example, when the nozzle hole 21a is arranged so that ink I is ejected in the gravity direction (downward in figure), ink I is ejected from the nozzle hole 21a when a pressure in the ink pressure chamber 25 is equal to or higher than the atmospheric pressure (air pressure), i.e., a positive pressure. In addition, when the pressure in the ink pressure chamber 25 is equal to or lower than −4.0 kPa (negative pressure representing pressure lower than atmospheric pressure), air bubbles may be formed in the nozzle hole 21a. The air bubbles can cause an ejection failure of ink.

As illustrated in FIG. 5, the ink circulating device 3 includes an ink casing 33 which includes a supply chamber 31 which communicates with the supply port 26a of the ink jet head 2, and a collecting chamber 32 which communicates with the ink discharging port 27a of the ink jet head 2. In addition, the ink circulating device 3 includes an ink supply pump 34, a circulation pump 35, and the pressure adjusting unit 36. The pressure adjusting unit 36 includes a first pressure adjusting unit 47 and a second pressure adjusting unit 48. The ink circulating device 3 also includes an ink supply pipe 31a, an ink return pipe 32a, and an ink supply pump 32b.

The supply chamber 31 is a liquid chamber for supplying ink I to the ink jet head 2. The collecting chamber 32 is a liquid chamber for collecting ink I from the ink jet head 2. A common wall 37 is disposed between the collecting chamber 32 and the supply chamber 31. The ink casing 33 is closed to the outside atmosphere (air).

The supply chamber 31 communicates with the supply port 26a of the ink jet head 2 through an ink supply pipe 26. An inflow hole 31b, which communicates with a circulation path 41a, is formed in the supply chamber 31. In addition, a communicating hole 31c, which communicates with a communication flow path 107 (refer to FIGS. 9A to 9C) of the first pressure adjusting unit 47, is formed in the supply chamber 31.

The collecting chamber 32 communicates with the ink discharging port 27a of the ink jet head 2 through an ink return pipe 27. A liquid supply hole 32c, which communicates with the inflow hole 31b of the supply chamber 31 through the circulation path 41a, is formed in the collecting chamber 32. The collecting chamber 32 has a communicating hole 32d which communicates with the second pressure adjusting unit 48 of the pressure adjusting unit 36. The collecting chamber 32 is connected to the ink cartridge 51 through a tube 52. In addition, the communicating hole 32d of the collecting chamber 32 is connected to a communication path 109 (refer to FIGS. 9A to 9C) of the second pressure adjusting unit 48.

The ink supply pump 34 supplies ink stored in the ink cartridge 51 to the collecting chamber 32. Alternatively, the ink supply pump 34 may supply ink to the supply chamber 31. For example, the ink supply pump 34 is a piezoelectric pump. The ink supply pump 34 according to the present embodiment includes a piezoelectric vibration plate which is obtained by bonding a piezoelectric element and a metallic plate, and a capacity of a pump chamber in the ink supply pump 34 is periodically changed by bending the piezoelectric vibration plate. The ink supply pump 34 supplies ink I to the collecting chamber 32 from the ink cartridge 51 due to a change in capacity of the pump chamber.

In addition, the ink circulating device 3 includes a circulation unit 40. The circulation unit 40 includes a circulation path 41a, a circulation pump 35 arranged on the circulation path 41a, and a filter 43. The circulation path 41a extends from the liquid supply hole 32c of the collecting chamber 32 to the inflow hole 31b of the supply chamber 31, as illustrated in FIG. 5.

The circulation pump 35 has the same structure as that of the ink supply pump 34, for example. The circulation pump 35 supplies ink I from the collecting chamber 32 to the supply chamber 31, and causes the ink I in the supply chamber 31 to be conveyed to the collecting chamber 32 through the ink jet head 2. As the circulation pump 35, for example, it is also possible to use a tube pump, a diaphragm pump, a piston pump, or the like.

The filter 43 is located along the circulation path 41a on a downstream side of the circulation pump 35 in the circulation direction, and removes foreign substances which are contained in ink I. For example, as the filter 43, it is possible to use a mesh filter of polypropylene, nylon, polyphenylene sulfide, stainless steel, or the like.

Air bubbles in ink I go up due to buoyance while ink is circulated from the collecting chamber 32 toward the supply chamber 31 by the circulation unit 40. The air bubbles which go up due to buoyance move to an empty space which is located above a liquid level of the collecting chamber 32, or a liquid level of the supply chamber 31, and are removed from ink.

As illustrated in FIG. 5, the ink circulating device 3 includes a first ink amount sensor 44a which measures an ink amount of the collecting chamber 32, and a second ink amount sensor 44b which measures an ink amount of the supply chamber 31. The first ink amount sensor 44a and the second ink amount sensor 44b vibrate a piezoelectric vibration plate using an AC voltage, for example, and thereby respectively detect vibration of ink which travels in the collecting chamber 32 or the supply chamber 31, and measure the ink amount. The ink amount sensor is not limited to these sensors, and may be a sensor which measures a height of a liquid level α1 of the collecting chamber 32 or a liquid level α2 of the supply chamber 31, for example, a sensor which measures a height of a liquid level using a height of a float including magnet in each of the collecting chamber 32 and the supply chamber 31, or a sensor which measures a height of a liquid level using reflection of light.

The ink circulating device 3 also includes a first pressure sensor 45a which detects pressure in the collecting chamber 32, and a second pressure sensor 45b which detects pressure of the supply chamber 31. The first and second pressure sensors 45a and 45b output pressure as an electrical signal using a semiconductor piezo-resistive pressure sensor, for example. The semiconductor piezo-resistive pressure sensor includes a diaphragm which receives pressure from the outside, and a semiconductor strain gauge which is formed on the surface of the diaphragm, and detects pressure by converting a change in electrical resistance due to a piezo-resistance effect which occurs in the strain gauge along with deformation of the diaphragm due to pressure from the outside into an electrical signal.

As illustrated in FIGS. 9A to 9C, the first pressure adjusting unit 47 of the pressure adjusting unit 36 includes a cylinder 101 which is connected to the supply chamber 31 so as to communicate therewith, a piston 103 which reciprocates in the cylinder 101, and a pulse motor 105 which causes the piston 103 to reciprocate in the vertical direction (direction of arrow H) in FIGS. 9A to 9C, and changes capacity of the cylinder 101.

The cylinder 101 is connected to a communication flow path 107 which communicates with the supply chamber 31. A first opening-closing unit 108 which opens or closes the communication flow path 107 is provided inside the communication flow path 107. The first opening-closing unit 108 includes an opening-closing valve 108a, and a spring 108b which urges the opening-closing valve 108a. The opening-closing valve 108a closes the communication flow path 107 with the urging force of the spring 108b, and opens the communication flow path 107 when the piston 103 pushes back the spring 108b.

The second pressure adjusting unit 48 includes a cylinder 102 which can communicate with the collecting chamber 32, a piston 104 which is arranged inside the cylinder 102, and a pulse motor 106 which causes the piston 104 to move in the vertical direction (direction of arrow H) in FIGS. 9A to 9C, and changes capacity of the cylinder 102.

The cylinder 102 is connected to a communication path 109 which communicates with the collecting chamber 32, and a communication pipeline 110 which causes the inside of the cylinder 102 to communicate with the atmosphere (air). A second opening-closing unit 111 which switches a communication state between the collecting chamber 32 and the inside of the cylinder 102 is provided inside the communication pipeline 110. The second opening-closing unit 111 includes a second opening-closing valve 111a, and a spring 111b which urges the second opening-closing valve 111a. The second opening-closing valve 111a closes off the communication pipeline 110 from the atmosphere with the urging force of the spring 111b, and opens the communication pipeline 110 when the piston 104 pushes back the spring 111b.

In addition, in the second pressure adjusting unit 48, when the piston 104 is located at a lower limit of the cylinder 102, an upper end of a communication path 109 in FIG. 9C which connects the collecting chamber 32 and the cylinder 102 is closed by the piston 104.

In addition, a communication flow path 112 connecting the cylinder 101 and the cylinder 102 is provided between the cylinder 101 of the first pressure adjusting unit 47 and the cylinder 102 of the second pressure adjusting unit 48.

The pressure adjusting unit 36 causes the piston 103 in the cylinder 101 of the first pressure adjusting unit 47 and the piston 104 in the cylinder 102 of the second pressure adjusting unit 48 to reciprocate in the H direction in FIG. 9B, respectively. Due to movements of the pistons 103 and 104, it is possible to change pressures of the air in the cylinders 101 and 102, and to control opening-closing of the communication pipeline 110 or the communication flow path 107 with respect to the atmosphere (air). The pressure adjusting unit 36 pressurizes or depressurizes the ink pressure chamber 25 of the ink jet head 2 by pressurizing or depressurizing gas in the collecting chamber 32, by the change in the pressure of the air, and opening-closing of the flow path.

Here, functions of the pressure adjusting unit 36 will be described with reference to FIGS. 9A to 9C.

In “STATE 1” illustrated in FIG. 9A, the piston 104 of the second pressure adjusting unit 48 is located at a position released to the atmosphere, and the piston 103 of the first pressure adjusting unit 47 is located at a communication position. In this state, paths of dashed arrows in FIG. 9A are formed, and both of the supply chamber 31 and the collecting chamber 32 are connected to the atmosphere (atmospheric release state).

For example, when the ink casing 33 which is empty is initially filled with ink from the ink cartridge 51 at the beginning of using the ink jet apparatus, positions of the pistons 103 and 104 of the first and second pressure adjusting units 47 and 48 are set at “STATE 1”.

In “STATE 2” which is illustrated in FIG. 9B, the piston 104 of the second pressure adjusting unit 48 is located at a home position at which the piston 104 does not communicate with the atmosphere, and the piston 103 of the first pressure adjusting unit 47 is located at a position at which the first opening-closing unit 108 does not communicate with the supply chamber 31. In this state, the collecting chamber 32 and the space in the cylinder 101 below the piston 103 communicate through a path of a dashed arrow in FIG. 9B, and the path does not extend to the atmosphere (closed state).

In addition, in this state, when the piston 103 of the first pressure adjusting unit 47 is vertically moved in the arrow H direction in FIG. 9B, pressure in the collecting chamber 32 increases or decreases. That is, when the piston 103 is moved upward in FIG. 9B, pressure in the collecting chamber 32 decreases due to increase in capacity of the cylinder 101. In contrast to this, when the piston 103 of the first pressure adjusting unit 47 is moved downward in FIG. 9B, pressure in the collecting chamber 32 increases due to decrease in capacity of the cylinder 101.

In STATE 3 which is illustrated in FIG. 9C, the piston 104 of the second pressure adjusting unit 48 is located at a position connected to the atmosphere, and the piston 103 of the first pressure adjusting unit 47 is located at a communication position at which the piston communicates with the supply chamber 31 by opening the first opening-closing unit 108. When the piston 103 of the first pressure adjusting unit 47 is moved in the vertical direction in order to maintain the pressure of the collecting chamber 32, a range between a position at which the piston 103 contacts a ceiling portion of the cylinder 101, and a position at which the piston 103 contacts the first opening-closing unit 108 become a movable range for a pressure adjustment.

Depending on a position of the piston 103 before starting a pressure adjustment, the piston 103 may go beyond the movable range when the piston 103 is moved in a direction to adjust the pressure. In this case, the piston 104 of the second pressure adjusting unit 48 is moved to the lower limit position, and the piston 103 of the first pressure adjusting unit 47 is moved to a limit position of the movable range in a direction opposite to the direction to adjust the pressure after the use of the ink jet apparatus. As a result, the collecting chamber 32 is closed, and the first pressure adjusting unit 47 is set to a state of being connected to the atmosphere. Since the second pressure adjusting unit 48 communicates with the atmosphere through a path of a dashed arrow in FIG. 9C, and both the supply chamber 31 and the collecting chamber 32 are in the closed state, a movement of the piston 103 does not affect the pressure of both of the chambers 31 and 32.

Subsequently, the piston 104 of the second pressure adjusting unit 48 is moved to the home position, the collecting chamber 32 is set to a closed state as illustrated in “STATE 2” in FIG. 9B, and the piston 103 of the first pressure adjusting unit 47 is moved in the adjusting direction, thereby obtaining an operating pressure.

As described above, the first pressure adjusting unit 47 and the second pressure adjusting unit 48 increase or decrease pressure in the collecting chamber 32 by the move of the pistons 103 and 104 in the cylinders 101 and 102, and can adjust the pressure in the circulation flow path by performing pressurizing or depressurizing. In other words, the pressure adjusting unit 36 functions as a gas supply unit which supplies air (gas) to the supply chamber 31 or the collecting chamber 32, adjusts the pressure of the ink pressure chamber 25 and thus the shape of the ink meniscus Me by adjusting the pressure of the supply chamber 31 or the collecting chamber 32.

Alternatively, the ink circulating device 3 adjusts the pressure of the ink pressure chamber 25 and thus the shape of the ink meniscus Me by replenishing ink by controlling the ink supply pump 34. In this case, the ink supply pump 34 functions as a liquid supply unit. In both cases, the ink circulating device 3 prevents unnecessary ink leakage or suctioning of air bubbles by maintaining pressure of the ink pressure chamber 25 in a range of −4.0 kPa to air pressure.

As illustrated in FIG. 2, the ink cartridge 51 of each color communicates with the corresponding ink circulating device 3 of the ink jet head unit 4 through the tube 52. Each of the ink cartridges 51 is arranged at a position which is relatively lower than the corresponding ink circulating device 3 in the gravity direction. In this manner, head pressure of ink in the ink cartridge 51 is held to be lower than a set pressure of the collecting chamber 32. In addition, in this manner, it is possible to supply new ink to the collecting chamber 32 from the ink cartridge 51 only when the ink supply pump 34 is driven.

As illustrated in FIG. 1, the head support unit 6 includes a carriage 61 which supports the plurality of ink jet head units 4, a transport belt 62 which causes the carriage 61 to reciprocate in the arrow. A direction, and a carriage motor 63 which drives the transport belt 62.

A medium moving unit 7 includes a table 71 to which a medium S is suctioned. The table 71 is attached onto a slide rail device 72, and reciprocates in the arrow B direction (refer to FIG. 2).

The maintenance unit 8 is disposed at a position in a scanning range of the ink jet head unit 4 in the arrow A direction, and out of a moving range of the table 71. The maintenance unit 8 is a container of which upper portion is open, and provided so as to vertically move (arrows C and D directions in FIG. 1).

The maintenance unit 8 includes a rubber blade 81 and a waste ink reception unit 82. The rubber blade 81 removes ink, dust, paper dust, or the like, which is attached to the nozzle plate 21 of the ink jet head 2. The waste ink reception unit 82 receives waste ink, dust, paper dust, or the like, which is removed using the blade 81. The maintenance unit 8 wipes off the surface of the nozzle plate 21 using the blade 81 by moving the blade 81 in the arrow B direction.

Hereinafter, a control system which controls operations of the ink jet apparatus 1 will be described with reference to the block diagram illustrated in FIG. 10.

A control substrate 500 includes a microcomputer 510 which controls the entire ink jet apparatus 1, a driving circuit 540 which drives the ink circulating device 3, an amplification circuit 541, a moving unit driving circuit 542 which drives the medium moving unit 7, and a driving circuit 543 (driving unit) which drives the ink jet head 2. The microcomputer 510 functions as a control unit.

The ink jet head unit 4 includes the ink circulating device 3 and the ink jet head 2. The microcomputer 510 includes a memory 520 which stores a program, various kinds of data, and the like, and an AD conversion unit 530 to which signals (voltages) are output from components of the ink circulating device 3 of the ink jet head unit 4.

The AD conversion unit 530 of the microcomputer 510 has a function of converting voltage values output from the first pressure sensor 45a and the second pressure sensor 45b. In addition, the microcomputer 510 is configured to calculate a pressure fluctuation speed V (ΔP/Δt) from a pressure fluctuation value ΔP which fluctuates during a sampling time Δt which is set.

The control substrate 500 is connected to a power source 550, a display device 560 which displays a state of the ink jet apparatus 1, and a keyboard 570 as an input device. The control substrate 500 is connected to driving units of various pumps and various sensors of the ink jet head unit 4. The control substrate 500 is connected to the table 71 of the medium moving unit 7, the slide rail device 72, a driving unit of the maintenance unit 8, and a carriage motor 63 of the transport belt 62.

Hereinafter, a liquid ejecting method using the ink jet apparatus 1 will be described.

When the ink jet apparatus 1 is operated to perform printing for the first time, each of the ink jet head units 4 is filled with ink I of color corresponding thereto, which is supplied from the corresponding ink cartridge 51.

In order to perform filling of ink I, the microcomputer 510 causes the ink jet head unit 4 to return to a standby position, and covers the nozzle plate 21 by lifting the maintenance unit in the arrow D direction (FIG. 1). Thereafter, the microcomputer 510 drives the ink supply pump 34, and operates to supply ink to the collecting chamber 32 from the ink cartridge 51. When the ink I reaches the liquid supply 32c in the collecting chamber 32, the microcomputer 510 operates to adjust the pressure of the supply chamber 31 and the collecting chamber 32 of the ink casing 33 by controlling the pressure adjusting unit 36, and drives the circulation pump 35.

As described above, the microcomputer 510 operates to perform initial filling of cyan ink, magenta ink, yellow ink, black ink, and white ink stored in the plurality of ink cartridges 51 to the plurality of ink jet head units 4, respectively. In addition, when the ink I reaches the liquid supply hole 32c of the collecting chamber 32 and the inflow hole 31b of the supply chamber 31, the microcomputer 510 operates to finish the initial filling of the ink I.

When the initial filling of ink I is finished, the pressure in the ink casing 33 is adjusted to a negative pressure so that the ink I does not leak from the nozzle holes 21a of the ink jet head 2, and air bubbles are not suctioned from the nozzle holes 21a. Due to the negative pressure of the ink casing 33, each of the nozzle holes 21a maintains the ink meniscus Me in a shape which is recessed towards the ink pressure chamber 25 side at a liquid droplet ejecting end thereof. In addition, also when the power source 550 of the ink jet apparatus 1 is turned off after the initial filling of ink I is finished, the ink casing 33 goes into a closed state, the ink meniscus Me in the nozzle hole 21a maintains the shape in the negative pressure state, and the ink leak is prevented.

When an instruction for ejection of ink is input through the keyboard 570, for example, after the initial filling of ink I, the microcomputer 510 controls the medium moving unit 7 to fix the medium S to the table 71 by suction of the medium S, and causes the table 71 to reciprocate in the arrow B direction. In addition, at this time, the microcomputer 510 operates to move the maintenance unit 8 in the arrow C direction. In addition, the microcomputer 510 operates to transport the carriage 61 in the direction of the medium S by controlling the carriage motor 63, and causes the plurality of ink jet head units 4 to reciprocate in the arrow A direction.

While the ink jet head unit 4 reciprocates in the arrow A direction along the transport belt 62, the distance h between the nozzle plate 21 of the ink jet head 2 and the medium S is maintained to be constant.

In addition, an image is formed on the medium S while causing the ink jet head 2 to reciprocate in a direction orthogonal to the transport direction of the medium S. The ink jet head 2 forms an image on the medium S by ejecting ink droplets ID from the nozzle holes 21a formed in the nozzle plate 21 according to a signal for forming an image.

At this time, the microcomputer 510 causes ink droplets ID to be ejected onto the medium S from the nozzle holes 21a by selectively driving one or more actuators 24 of the ink jet head 2 by image signals corresponding to image data stored in the memory 520, for example. In addition, at this time, the microcomputer 510 drives the circulation pump 35. Ink I which returned from the ink jet head 2 is recirculated to the ink jet head 2 through the collecting chamber 32, the filter 43, and the supply chamber 31.

The ink jet apparatus 1 removes air bubbles or foreign substances which are contained into ink I by circulating the ink I, and keeps a good ink ejecting performance. Accordingly, a quality of an image printed with the ink jet head unit 4 is maintained.

Pressure of the ink in the ink casing 33 fluctuates due to ejection of ink droplets ID from the nozzle hole 21a, driving of the circulation pump 35, or the like. In order to maintain the pressure of the ink in the ink casing 33 in a stable range within which no leakage of ink and no suction of air bubbles from the nozzle hole 21a occur, the microcomputer 510 operates to adjust pressure of the ink in the ink casing 33 by switching driving of the pistons 103 and 104 of the pressure adjusting unit 36 or the ink supply pump 34.

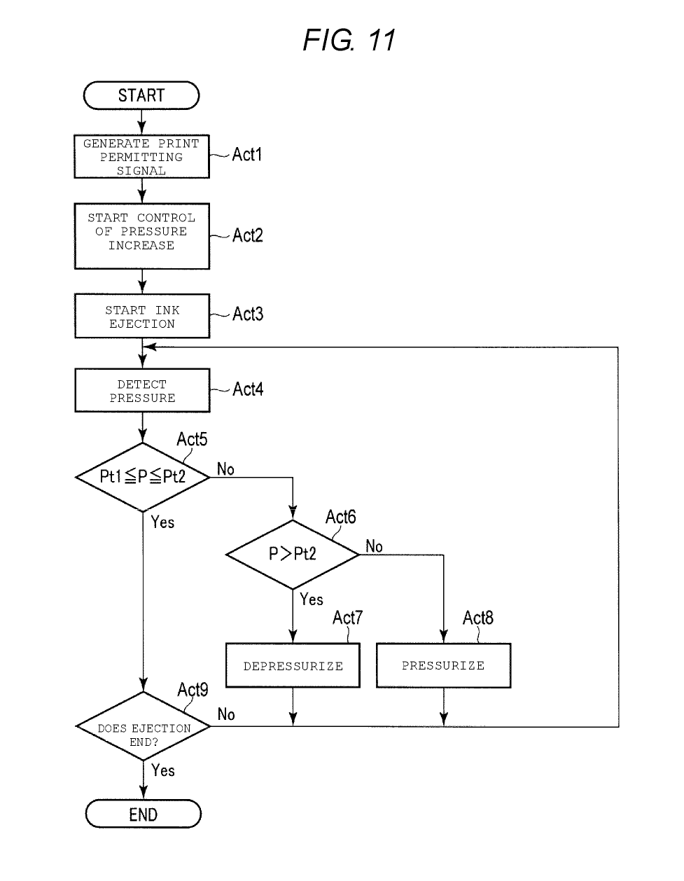

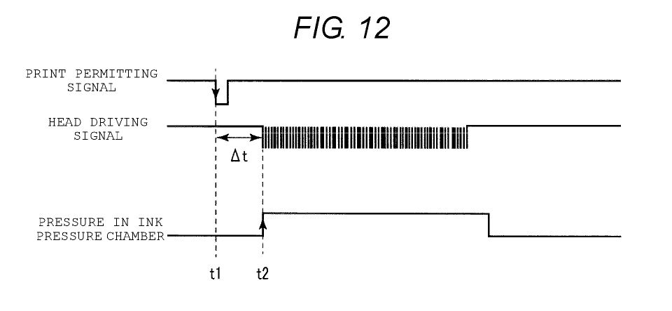

Next, control operations for stabilizing a shape of the ink meniscus Me in each nozzle hole 21a will be described with reference to the flowchart illustrated in FIG. 11 and the timing chart illustrated in FIG. 12. In addition, here, in the ink jet head unit 4 of each color, a lower limit of a pressure value P that does not cause the suction of air bubbles from the nozzle hole 21a is referred to as Pt1, and an upper limit of a pressure value P that does not cause the leak of ink from the nozzle hole 21a is referred to as Pt2.

For example, when a printing command from an operator is input through the keyboard 570, the keyboard 570 outputs a “print permitting signal” as a command for ejecting liquid droplets to the microcomputer 510, as illustrated in FIG. 11 (ACT 1). In the timing chart in FIG. 12, an output timing of the “print permitting signal” is denoted by t1.

When the “print permitting signal” is output, the microcomputer 510 starts a preparation for printing such as developing of a printed image using the signal as a trigger, and starts a control of pressure increase (ACT 2). In FIG. 12, a timing at which the pressure of the ink in the ink pressure chamber 25 increases after starting the control of pressure increase is denoted by t2.

In the control of pressure increase, the microcomputer 510 increases the pressure of the ink in the ink pressure chamber 25 up to a pressure that does not cause the leak of ink from the nozzle hole 21a (equal to or less than upper limit value Pt2). In addition, in the control of pressure increase, the microcomputer 510 controls driving of the first pressure adjusting unit 47 and the second pressure adjusting unit 48 through the driving circuit 540, and causes the pressure of the ink in the ink pressure chamber 25 to increase. Alternatively, the microcomputer 510 operates to increase pressure of the ink in the ink pressure chamber 25 by controlling driving of the ink supply pump 34 through the driving circuit 540.

When the control of pressure increase is started, the microcomputer 510 starts an ejecting operations of ink droplets based on a head driving signal (driver control signal) output to the driving circuit 543, and printing is started (ACT 3). The head driving signal is generated based on the print permitting signal a period of time (Δt) after the print permitting signal is generated. In FIG. 12, the ejecting operation of ink droplets is started at the timing t2, at which the pressure in the ink pressure chamber 25 increases. However, the timing to increase the pressure of ink in the ink pressure chamber 25 may be a period of time (Δt) between the output of the “print permitting signal” (t1) and the start of the ejecting operation of the ink droplets (t2).

That is, when ink droplets are ejected after the period of time Δt after the output of the “print permitting signal”, the pressure of the ink in the ink pressure chamber 25 has increased to an operating pressure. For that reason, it is possible to prevent a shape of the ink meniscus Me in the nozzle hole 21a from being changed due to the ejection of ink droplets.

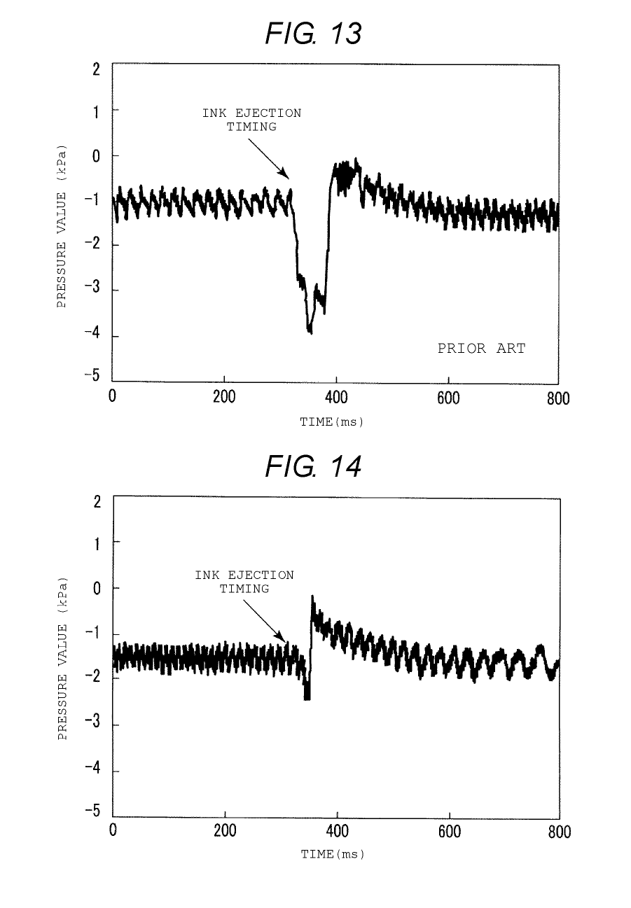

FIG. 13 illustrates a pressure change of the ink in the ink pressure chamber 25 at a time of ejection of ink droplets according to a comparative example where the control of pressure increase in ACT 2 is omitted, and FIG. 14 illustrates a pressure change of the ink in the ink pressure chamber 25 at a time of ejection of ink droplets according to the present embodiment when the control of pressure increase in ACT 2 is performed. According to FIGS. 13 and 14, it is possible to suppress a pressure change of the ink in the ink pressure chamber 25 at a time of the ejection of ink droplets by increasing the pressure of the ink in the ink pressure chamber 25 to an operating pressure before starting the ejecting operation of ink droplets. In contrast to this, when the control of pressure increase is omitted (FIG. 13), the ink in the ink pressure chamber 25 is depressurized to −4 kPa immediately after the ejection of ink droplets. For that reason, there is a concern that air bubbles may generate in the ink at the meniscus Me.

After starting the ejecting operation of ink droplets in ACT 3, the microcomputer 510 calculates a pressure value P of the ink at the nozzle hole 21a based on a pressure value of the ink in the collecting chamber 32 which is detected using the first pressure sensor 45a, and a pressure value of the ink in the supply chamber 31 which is detected using the second pressure sensor 45b (ACT 4).

Then, whether or not the pressure value P is in a stable range, that is, whether or not Pt1≦P≦Pt2 is satisfied, is determined (ACT 5). When the pressure value P does not satisfy Pt1≦P≦Pt2, whether or not the pressure value P exceeds the upper limit of the stable range, that is, whether or not P>Pt2 is satisfied, is determined (ACT 6). When Pt1≦P≦Pt2 is not satisfied (No in ACT 5), and P>Pt2 is not satisfied (No in ACT 6), that is, when the pressure value P is lower than the lower limit Pt1, the microcomputer 510 operates to adjust the pressure value by performing a pressurizing operation by driving the pressure adjusting unit 36 (ACT 8).

On the other hand, when P>Pt2 is satisfied (Yes in ACT 6), the microcomputer 510 drives the first pressure adjusting unit 47 and the second pressure adjusting unit 48 to depressurize the ink pressure chamber 25 by decreasing the pressure in the ink casing 33 (ACT 7).

As described above, according to the present embodiment, it is possible to prevent pressure of the ink from excessively decreasing when ink droplets are ejected, by increasing the pressure of the ink in the ink pressure chamber 25 before starting the ejecting operation of the ink droplets, by controlling a first pressure adjusting pump 51a, a second pressure adjusting pump 52a, and ink supply pump 34. In this manner, it is possible to prevent the ink meniscus Me from remarkably recessing toward the ink pressure chamber 25 after the ejection of ink droplets, prevent air bubbles from being contained in the ink at the ink meniscus Me, and stably perform ejection of the ink droplets.

The embodiment described above is an example, and there is no intention of limiting the scope of the invention. The embodiment can be performed in various forms other than that, and it is possible to perform various omissions, substitutions, and modifications without departing from the scope of the invention. The embodiment or modifications thereof are included in the scope of the invention, and are included in the invention which is described in claims, and equivalents thereof.

For example, in the above embodiment, the ink jet apparatus causes part of ink to be ejected while circulating the other part of the ink. Alternatively, it is also possible to apply the above embodiment to an apparatus which ejects liquid other than ink. As a liquid droplet ejecting apparatus which ejects liquid other than ink, for example, there is an apparatus which ejects liquid containing conductive particles for forming a wiring pattern of a printed circuit board, or the like.

In addition, in the above embodiment, ink droplets ID are ejected by causing a pressure change of ink I in the ink pressure chamber 25. Alternatively, ink droplets may be ejected by deforming a vibration plate using static electricity, using thermal energy such as a heater, or the like.

In addition, it is possible to arbitrarily set an attaching position of the ink cartridge 51. For example, when the ink cartridge 51 is set at a position which is higher than the ink circulating device 3, head pressure of ink in the ink cartridge 51 becomes higher than set pressure of the collecting chamber 32. When the ink cartridge 51 is set at a position which is higher than the ink circulating device 3, it is possible to supply ink to the supply chamber 31 from the ink cartridge 51 by opening or closing an electromagnetic valve using head pressure.

In addition, a structure of the pressure adjusting unit 36 is not limited to the above piston mechanism, and for example, it is possible to use a tube pump, a bellows pump, or the like. In this case, the pressure adjusting unit 36 performs a pressure adjustment in which pressure is increased or decreased, by supplying gas to the supply chamber 31 or the collecting chamber 32 as a liquid chamber, or causing gas to be released from the supply chamber 31 or the collecting chamber 32.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid droplet ejecting apparatus, comprising:
a liquid chamber;
a head including a plurality of pressure chambers to which liquid is supplied from the liquid chamber, each pressure chamber having a nozzle;
a driver configured to cause liquid droplets to be ejected from the nozzles,
a pressure adjuster configured to adjust pressure of liquid in the liquid chamber; and
a controller configured to output a control signal to control the driver to cause ejection of the liquid droplets, and cause pressure of the liquid in the liquid chamber to increase at the time, or before, the control signal starts to be output, by controlling the pressure adjuster.

2. The liquid droplet ejecting apparatus according to claim 1, wherein
the controller starts to control the pressure adjuster at the time, or before, the control signal starts to be output to the driver.

3. The liquid droplet ejecting apparatus according to claim 1, wherein
the pressure of the liquid in the liquid chamber is increased at the time, or before, the liquid droplets are ejected from the nozzles.

4. The liquid droplet ejecting apparatus according to claim 1, wherein
the pressure of the liquid in the liquid chamber is increased to a value that does not cause ejection of the liquid droplets from the nozzles.

5. The liquid droplet ejecting apparatus according to claim 1, wherein
the pressure adjuster increases the pressure of the liquid in the liquid chamber by introducing additional liquid into the liquid chamber.

6. The liquid droplet ejecting apparatus according to claim 1, wherein
the pressure adjuster increases the pressure of the liquid in the liquid chamber by introducing additional gas into the liquid chamber.

7. The liquid droplet ejecting apparatus according to claim 1, wherein
the increased pressure of the liquid is maintained at least until the controller ceases to output the control signal.

8. The liquid droplet ejecting apparatus according to claim 1, further comprising:
a pressure sensor configured to detect pressure in the liquid chamber, wherein
the controller is further configured to control the pressure adjuster to cause the pressure of the liquid in the liquid chamber to be within an operating range, based on pressure detected by the pressure sensor after the control signal starts to be output.

9. A liquid circulating device that causes liquid to be supplied to a head and recovered from the head, the device comprising:
a liquid chamber;
a pressure adjuster configured to adjust pressure of liquid in the liquid chamber; and
a controller configured to output a control signal to cause ejection of liquid droplets from the head, and cause pressure of the liquid in the liquid chamber to increase at the time or before the control signal starts to be output, by controlling the pressure adjuster.

10. The liquid circulating device according to claim 9, wherein
the pressure adjuster increases the pressure of the liquid in the liquid chamber by introducing additional liquid into the liquid chamber.

11. The liquid circulating device according to claim 9, wherein
the pressure adjuster increases the pressure of the liquid in the liquid chamber by introducing gas into the liquid chamber.

12. The liquid circulating device according to claim 9, wherein
the increased pressure of the liquid is maintained at least until the controller ceases to output the control signal.

13. An image forming apparatus, comprising:
a medium conveyer configured to convey a medium;
an image forming unit configured to form an image on the medium with ink, and including:
an ink chamber;
a head including a plurality of pressure chambers to which ink is supplied from the ink chamber, each pressure chamber having a nozzle;
a driver configured to cause ink droplets to be ejected from the nozzles; and
a pressure adjuster configured to adjust pressure of ink in the ink chamber; and
a controller configured to output a control signal to control the driver to cause ejection of the ink droplets, and cause pressure of the ink in the ink chamber to increase at the time, or before, the control signal starts to be output, by controlling the pressure adjuster.

14. The image forming apparatus according to claim 13, wherein
the controller starts to control the pressure adjuster at the time, or before, the control signal starts to be output to the driver.

15. The image forming apparatus according to claim 13, wherein
the pressure of the ink in the ink chamber is increased at the time, or before, the ink droplets are ejected from the nozzles.

16. The image forming apparatus according to claim 13, wherein
the pressure of the ink in the ink chamber is increased to a value that does not cause ejection of the ink droplets from the nozzles.

17. The image forming apparatus according to claim 13, wherein
the pressure adjuster increases the pressure of the ink in the ink chamber by introducing additional ink into the ink chamber.

18. The image forming apparatus according to claim 13, wherein
the pressure adjuster increases the pressure of the ink in the ink chamber by introducing gas into the ink chamber.

19. The image forming apparatus according to claim 13, wherein
the increased pressure of the ink is maintained at least until the controller ceases to output the control signal.

20. The image forming apparatus according to claim 13, wherein
the image forming unit further includes a pressure sensor configured to detect pressure in the ink chamber, and
the controller is further configured to control the pressure adjuster to cause the pressure of the ink in the ink chamber to be within an operating range, based on pressure detected by the pressure sensor after the control signal starts to be output.
